(19) United States
(12) Patent Application Publication
(10) Pub. No.: US 2026/0230764 A1
(43) Pub. Date: Aug. 6, 2026

(54) METHOD AND ELECTRONIC DEVICE FOR SELECTING MICROPHONE

(71) Applicant: Samsung Electronics Co., Ltd., Suwon-si (KR)

(72) Inventors: Gunwoo LEE, Suwon-si (KR); Sangeun KIM, Suwon-si (KR); Hangil MOON, Suwon-si (KR); Kyoungho BANG, Suwon-si (KR); Soonho BAEK, Suwon-si (KR); Jaemo YANG, Suwon-si (KR); Brian HAN, Suwon-si (KR)

(21) Appl. No.: 19/631,225

(22) Filed: Mar. 27, 2026

Related U.S. Application Data
(63) Continuation of application No. PCT/KR2024/012909, filed on Aug. 28, 2024.

(30) Foreign Application Priority Data
Oct. 20, 2023 (KR) 10-2023-0141329
Nov. 24, 2023 (KR) 10-2023-0165102

(51) Int. Cl. H04R 29/00; G10L 25/60; H04R 3/00

(52) U.S. Cl. CPC H04R 29/005; G10L 25/60; H04R 3/005

(57) ABSTRACT

A first electronic device may include: a wearing detection sensor; an utterance detection sensor; a communication circuit for communication with a second electronic device; a first microphone; memory; and a processor. The processor can: acquire utterance time point information in response to the first electronic device being worn; share the acquired utterance time point information with the second electronic device through the communication circuit; acquire first voice quality information corresponding to the first electronic device and second voice quality information corresponding to the second electronic device based on the utterance time point information; select one of the first electronic device or the second electronic device based on the first voice quality information and the second voice quality information; and based on the first electronic device being selected, select the first microphone of the first electronic device.

### CROSS-REFERENCE TO RELATED APPLICATIONS

This application is a continuation of International Application No. PCT/KR2024/012909 designating the United States, filed on August 28, 2024, in the Korean Ministry of Intellectual Property Receiving Office and claiming priority to Korean Patent Application Nos. 10-2023-0141329, filed on October 20, 2023, and 10-2023-0165102, filed on November 24, 2023, in the Korean Ministry of Intellectual Property, the disclosures of each of which are incorporated by reference herein in their entireties.

### BACKGROUND

### FIELD

The disclosure relates to a method and an electronic device for selecting a microphone.

### DESCRIPTION OF RELATED ART

With the development of digital technologies, various types of electronic devices, such as mobile communication terminals, smartphones, tablet personal computers (PCs), personal digital assistants (PDAs), electronic notebooks, notebooks, wearable devices, internet of things (IoT) devices, and/or audible devices, are widely used. Among electronic devices, some wearable electronic devices (e.g., wireless earphones and wearable watches) are becoming essential devices in everyday life.

A wearable electronic device may include various types of audio output devices (e.g., a headset, an earphone, or a true wireless stereo (TWS) earphone). While being mounted on a part (e.g., ear) of a user's body, the wearable electronic device (e.g., a TWS earphone) may output an audio signal (e.g., a voice signal) into the ear through a speaker, and acquire an audio signal (e.g., a voice signal) of an external environment through a microphone. For example, in a case where a user wearing a wearable electronic device calls another party, the wearable electronic device may output the other party’s (e.g., the other party on the call) voice data through a speaker and may acquire the user’s voice data through a microphone. The wearable electronic device may transmit the acquired voice data to an electronic device of the other party.

An electronic device (e.g., a smartphone or a portable terminal device) may perform a phone call with an external electronic device (e.g., a smartphone of the other party) while being operatively and communicatively (e.g., through Bluetooth™ (BT) communication) connected to a wearable electronic device (e.g., a true wireless stereo (TWS) earphone).

For example, the wearable electronic device (e.g., TWS) may be operatively connected to an electronic device while being worn on a part (e.g., an ear) of a user’s body. During a call connection between the electronic device and the external electronic device, the wearable electronic device may acquire a voice signal of the user using the microphone, and transmit the acquired voice signal to the external electronic device. In addition, the wearable electronic device may acquire a voice signal of the other party using the external electronic device, and output the voice signal of the other party using the speaker. The wearable electronic device may be worn in a state of being at least partially inserted into the user's ear.

While a wearable electronic device is mounted on a part (e.g., ear) of a human body, a microphone of the wearable electronic device and a user’s mouth may be physically spaced apart from each other by a predetermined distance. In acquiring the user's voice signal (e.g., voice data) by the wearable electronic device, a noise signal from the external environment may be mixed, and a signal to noise ratio (SNR) (e.g., a ratio value indicating the magnitude of a voice signal relative to the magnitude of an ambient noise signal) may be relatively low. For example, in an audio signal acquired through a microphone, a ratio of a noise signal is relatively higher than a voice signal, it may be more difficult to remove the noise signal. This may cause degradation of noise removal performance.

### SUMMARY

According to an example embodiment, in a situation in which an audio signal is acquired through a microphone, a wearable electronic device may identify an utterance time point in order to more accurately distinguish a voice signal and a noise signal, and may acquire a voice signal having a relatively better quality, based on the identified utterance time point. According to an example embodiment, a microphone by which an audio signal having a relatively better voice quality is acquired may be selected from among multiple microphones included a wearable electronic device and an electronic device connected to the wearable electronic device, and the disclosure is to provide a user with a call service having a better voice quality.

According to various example embodiments, a first electronic device may include: a wearing detection sensor, an utterance detection sensor (e.g., a voice pick-up unit (VPU), a communication circuit configured to provide a communicative connection to a second electronic device, a first microphone, memory, and at least one processor, comprising processing circuitry, operatively connected to the wearing detection sensor, the utterance detection sensor, the communication circuit, the first microphone, and/or the memory, wherein at least one processor, individually and/or collectively, may be configured to cause the first electronic device to: in response to the first electronic device being worn on a part of a human body, acquire utterance time point information of a user using the utterance detection sensor, share the acquired utterance time point information with the second electronic device through the communication circuit, acquire, based on the utterance time point information, first voice quality information corresponding to the first electronic device and second voice quality information corresponding to the second electronic device, select one of the first electronic device and the second electronic device, based on the first voice quality information and the second voice quality information, and based on the first electronic device being selected, select the first microphone of the first electronic device.

A method for selecting a microphone according to various example embodiments may include: in response to a first electronic device being worn on a part of a human body, acquiring utterance time point information of a user using an utterance detection sensor of the first electronic device, sharing the acquired utterance time point information with a second electronic device operatively and communicatively connected to the first electronic device, acquiring, based on the utterance time point information, first voice quality information corresponding to the first electronic device and second voice quality information corresponding to the second electronic device, selecting one of the first electronic device and the second electronic device, based on the first voice quality information and the second voice quality information, and based on the first electronic device being selected, selecting a first microphone of the first electronic device.

According to various example embodiments, a non-transitory computer-readable storage medium (or a computer program product) storing one or more programs for executing a method for selecting a microphone may be described. According to an example embodiment, the one or more programs may include instructions which, when executed by at least one processor, comprising processing circuitry, individually and/or collectively, of an electronic device, cause the electronic device to: in response to a first electronic device being worn on a part of a human body, acquiring utterance time point information of a user using an utterance detection sensor of the first electronic device, sharing the acquired utterance time point information with a second electronic device operatively and communicatively connected to the first electronic device, acquiring, based on the utterance time point information, first voice quality information corresponding to the first electronic device and second voice quality information corresponding to the second electronic device, selecting one of the first electronic device and the second electronic device, based on the first voice quality information and the second voice quality information, and based on the first electronic device being selected, selecting a first microphone of the first electronic device.

According to various example embodiments of the disclosure, a wearable electronic device (e.g., a TWS earphone) may include a first electronic device and a second electronic device which are worn on both ears, respectively. The first electronic device may detect an utterance time point of a user, and may share utterance time point information with the second electronic device. The wearable electronic device may compare, based on the utterance time point information, a voice quality for a first audio signal acquired based on a first microphone of the first electronic device and a voice quality for a second audio signal acquired based on a second microphone of the second electronic device. The wearable electronic device may select a microphone having a relatively better voice quality, thereby providing a user with a call service based on good voice quality using the selected microphone.

According to an example embodiment, a wearable electronic device may share utterance time point-related information between a first electronic device and a second electronic device, and at least partially remove a noise signal included in an acquired audio signal, based on the utterance time point-related information. For example, an utterance time point can be accurately detected, and the noise signal included in the audio signal can be removed with reference to the utterance time point, and thus the accuracy of measuring voice quality can be enhanced. According to an embodiment, the wearable electronic device may select a microphone having a better acquired voice quality, and provide a user with a call service having a better voice quality.

The advantageous effects obtainable from the disclosure are not limited to the above-described effects, and other advantageous effects which are not mentioned herein can be clearly understood from the following description by those skilled in the art to which the disclosure pertains.

### BRIEF DESCRIPTION OF THE DRAWINGS

In relation to the description of the drawings, the same or similar reference numerals may be used for the same or similar elements. Further, the above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various example embodiments.

FIG. 2 is a diagram illustrating an example of performing a call using a second electronic device included in a wearable electronic device when a first electronic device included in the wearable electronic device is mounted on a part of a human body, according to various example embodiments.

FIG. 3 is a block diagram illustrating an example configuration of a first electronic device and a second electronic device included in a wearable electronic device according to various example embodiments.

FIG. 4 is a flowchart illustrating an example method of comparing voice qualities corresponding to multiple microphones, respectively, and selecting a microphone having a relatively better voice quality according to various example embodiments.

FIG. 5 is a diagram illustrating that a first electronic device performs a call using a microphone of a second electronic device while the first electronic device is worn on a part of a human body, according to various example embodiments.

FIG. 6 is a signal flow diagram illustrating an example operation in which a call is performed based on a microphone of a second electronic device while a first electronic device is worn on a part of a human body, according to various example embodiments.

FIG. 7 is a diagram illustrating that a wearable electronic device performs a call using a microphone of an external electronic device while being worn on a part of a human body, according to various example embodiments.

FIG. 8 is a signal flow diagram illustrating an example operation in which while a wearable electronic device is worn on a part of a human body, a call is performed based on a microphone of an external electronic device, according to various example embodiments.

FIG. 9 is a diagram illustrating an example configuration of data shared between a first electronic device and a second electronic device according to various example embodiments.

### DETAILED DESCRIPTION

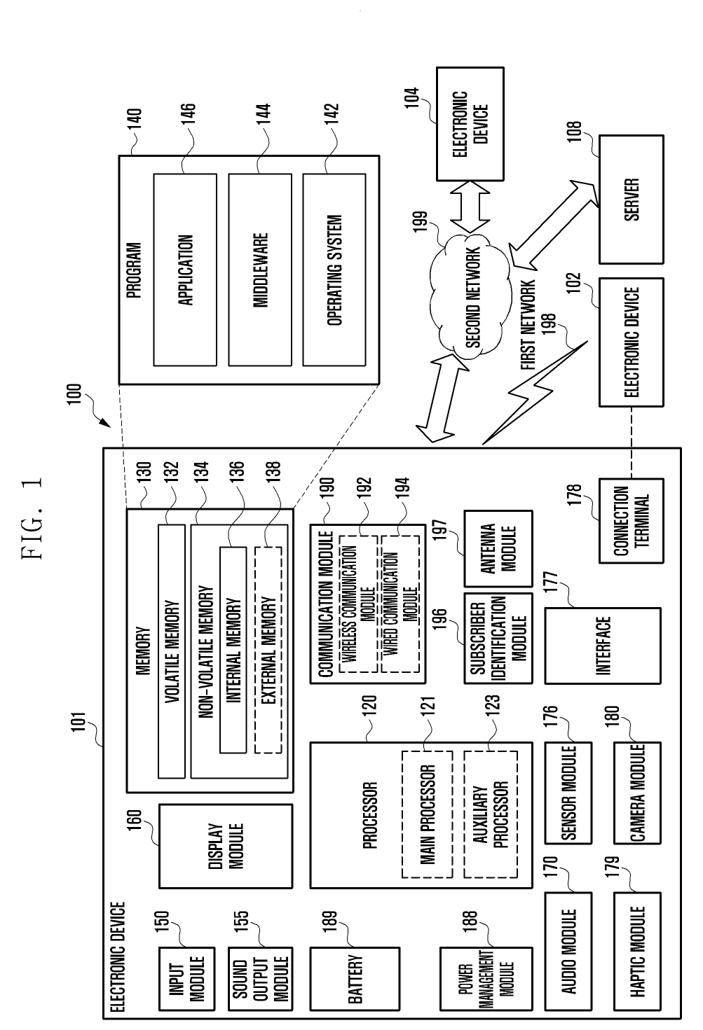

FIG. 1 is a block diagram illustrating an example electronic device 101 in a network environment 100 according to various example embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102)(e.g., a speaker or a headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). For example, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

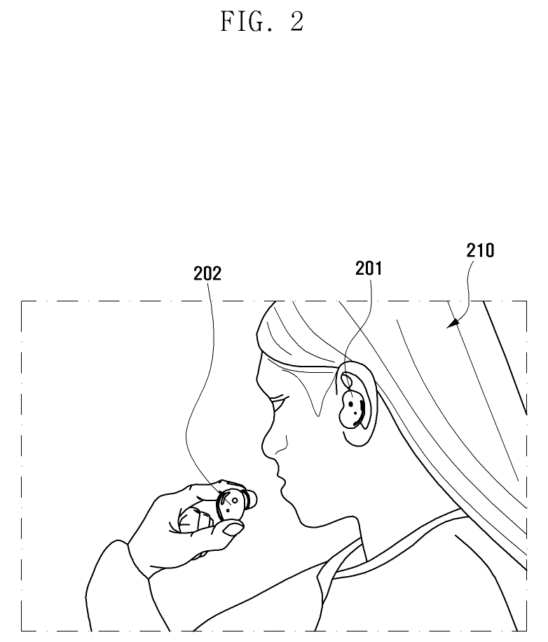

FIG. 2 is a diagram illustrating an example of performing a call using a second electronic device included in a wearable electronic device when a first electronic device included in the wearable electronic device is mounted on a part of a human body, according to various example embodiments.

Electronic devices 201 and 202 illustrated in FIG. 2 may be at least partially similar to the electronic device 101 of FIG. 1, or may further include various embodiments of the electronic device 101. The electronic devices 201 and 202 illustrated in FIG. 2 may include a wireless earphone corresponding to a wearable electronic device. The electronic devices 201 and 202 may be at least partially worn on a part (e.g., ear) of a user’s 210 body. The electronic device 201 and 202 may include a first electronic device 201 worn on the left ear of the user 210 and a second electronic device 202 worn on the right ear of the user 210. According to an embodiment, the position at which each of the first and second electronic devices 201 and 202 is worn may not be limited. For example, when the first electronic device 201 is worn on one ear of the user between the first electronic device 201 and the second electronic device 202, the second electronic device 201 may be worn on the other ear of the user.

According to various embodiments referring to FIG. 2, an electronic device 201 or 202 (e.g., a hearing device, an earphone, a wireless earphone, a TWS earphone, or a wearable electronic device) which can be worn a part (e.g., an ear) of a user’s body may be operatively and communicatively (e.g., short-range communication, Bluetooth™ (BT) communication, wireless fidelity (Wi-Fi) Direct communication, or infrared data association (IrDA) communication) connected to an external electronic device (e.g., a smartphone or a portable terminal device). For example, the electronic devices 201 and 202 may include at least one of a wireless earphone, a wired earphone, and/or a headset, which is wearable on the user's ear. The electronic devices 201 and 202 may function as a speaker that provides an audio service (e.g., a music service) to the user, or as a mic (e.g., a microphone) that transfers the user’s voice (e.g., an audio source, an audio signal, voice data, or utterance data) to another electronic device (e.g., an external electronic device). For example, the electronic devices 201 and 202 may include at least one speaker and at least one microphone. For example, the electronic devices 201 and 202 may be worn on a part (e.g., an ear or an earlobe) of the user's body and may include a wearing detection sensor (not illustrated) for determining whether the electronic device 201 or 202 is worn on the body part and an utterance detection sensor (not illustrated) for determining whether the user 210 is generating an utterance.

According to an embodiment, the electronic device 201 or 202 may not be limited to a TWS earphone, and may include various types of other electronic devices capable of providing an audio signal (e.g., voice data, or the other party’s voice signal during a call) to the user 210 through a speaker, or acquiring an audio signal (e.g., voice data) of the user 210 through a microphone.

Referring to FIG. 2, while wearing the first electronic device 201 on a part (e.g., an ear) of the body between the electronic devices 201 and 202, the user 210 may hold the second electronic device 202 to bring the same near the user’s 210 mouth. For example, it may be a situation in which the user 210 may bring the electronic device 202 near his or her mouth in order to more accurately transmit the user’s own voice to the other party, in a situation in which the user 210 uses the electronic devices 201 and 202 to perform a phone call. For example, it may be a situation in which the user 210 may move the second electronic device 202 (e.g., a microphone of the second electronic device 202) near his or her mouth in order to more accurately acquire the user's voice, in an environment in which a lot of noise is generated around.

According to an embodiment, the first electronic device 201 may be used as an output device (e.g., a speaker) for providing the user with a voice signal of the other party, and the second electronic device 202 may be used as an input device (e.g., a microphone) for acquiring a voice signal of the user.

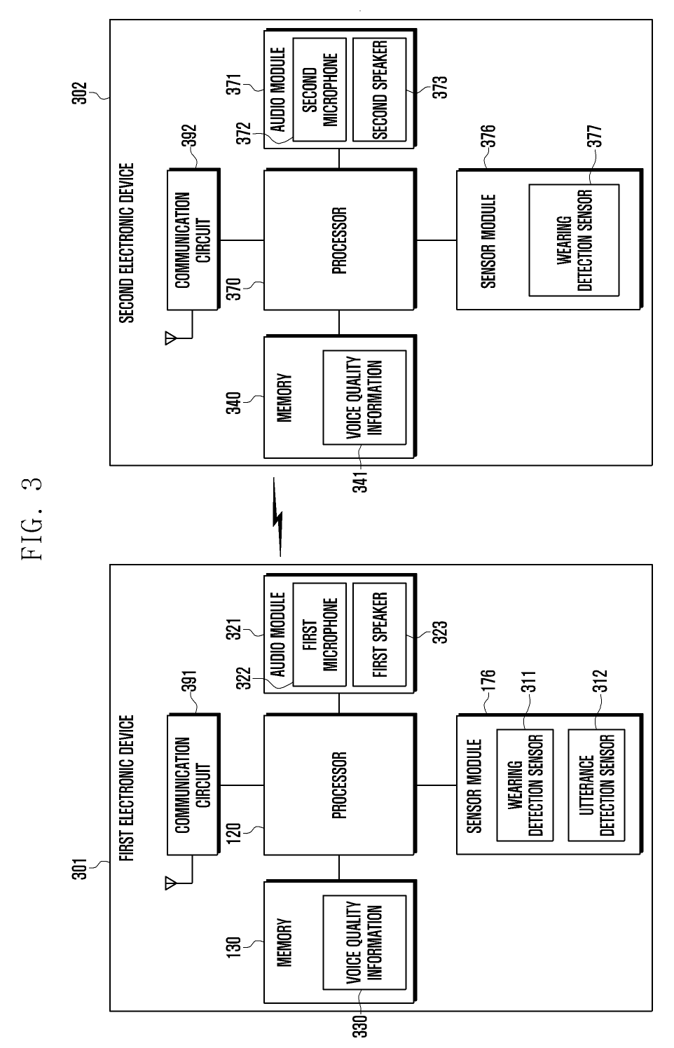

According to an embodiment, the first electronic device 201 may include at least one sensor (for example, a wearing detection sensor, an acceleration sensor, a gyroscope sensor, and/or a grip sensor) for determining whether the first electronic device 201 is worn on a part (e.g., an ear) of the user 201’s body. According to an embodiment, the first electronic device 201 may include an utterance detection sensor (for example, an utterance detection sensor 312 of FIG. 3) for determining whether the user 201 wearing the first electronic device 201 generates an utterance.

According to an embodiment, the first electronic device 201 may detect a situation in which the first electronic device is mounted on a part (e.g., an ear) of the user 210’s body using a wearing detection sensor (e.g., a wearing detection sensor 311 of FIG. 3), and may identify a time point (e.g., an utterance start time point) at which the user 210 generates an utterance, using the utterance detection sensor (e.g., the utterance detection sensor 312 of FIG. 3), in response to the situation in which the first electronic device 201 is mounted on the part of the body. The first electronic device 201 may share the identified utterance time point information with the second electronic device 202. The first electronic device 201 may measure the voice quality (e.g., first voice quality information) of the audio signal acquired through the microphone of the first electronic device 201, based on the utterance time point information. For example, the audio signal may include the user 201’s voice signal and a noise signal of the surrounding environment. The voice quality of the audio signal may refer to quality information of the user 210's voice signal included in the audio signal. According to an embodiment, the first electronic device 201 may acquire first voice quality information corresponding to the first electronic device 201, based on the utterance time point information. In this case, the second electronic device 202 may measure the voice quality (e.g., second voice quality information) of the audio signal acquired through the microphone of the second electronic device 202, based on the identified utterance time point information. According to an embodiment, the second electronic device 202 may acquire second voice quality information corresponding to the second electronic device 202, based on the utterance time point information. For example, the first electronic device 201 and the second electronic device 202 may differ in at least one of the placement position, posture, shape, distance from the mouth (e.g., an utterance point) to the device, and the relative direction to the mouth, and thus the first voice quality information corresponding to the first electronic device 201 and the second voice quality information corresponding to the second electronic device 202 may be measured to be different from each other. According to an embodiment, the first electronic device 201 may compare and analyze the first and second voice quality information, and may determine an electronic device having a relatively better voice quality. For example, the first electronic device 201 may at least partially control a corresponding electronic device so that a microphone of the electronic device having a relatively better voice quality is activated.

According to an embodiment, the first electronic device 201 may share the user’s utterance time point information with multiple electronic devices, and may acquire an audio signal through some of the multiple electronic devices, based on the shared utterance time point information. The first electronic device 201 may compare the voice quality information, based on the audio signals acquired from some of the multiple electronic devices, and may select an electronic device having a relatively better voice quality. For example, the first electronic device 201 may at least partially control the selected electronic device using the voice acquired through the microphone of the selected electronic device. For example, the above-described operations may be configured to be automatically performed by the first electronic device 201. According to an embodiment, the first electronic device 201 may periodically or aperiodically identify whether the user 210 has generated an utterance, and in response to a situation in which the user 210 has generated an utterance, perform the above-described operations.

FIG. 3 is a block diagram illustrating an example configuration of a first electronic device and a second electronic device included in a wearable electronic device according to various example embodiments.

A first electronic device 301 of FIG. 3 may be at least partially similar to the electronic device 101 of FIG. 1 and/or the first electronic device 201 of FIG. 2, and may further include various embodiments of the first electronic device 201. A second electronic device 302 of FIG. 3 may be at least partially similar to the electronic devices 102 and 104 of FIG. 1 and/or the second electronic device 202 of FIG. 2, and may further include various embodiments of the second electronic device 202.

Referring to FIG. 3, the first electronic device 301 (e.g., the first electronic device 201 of FIG. 2) may include a processor (e.g., including processing circuitry) 120 (e.g., the processor 120 of FIG. 1), memory 130 (e.g., the memory 130 of FIG. 1), a sensor module (e.g., including at least one sensor) 176 (e.g., the sensor module 176 of FIG. 1), an audio module (e.g., including audio circuitry) 321 (e.g., the audio module 170 of FIG. 1), and/or a communication circuit 391 (e.g., the communication module 190 of FIG. 1). For example, the sensor module 176 may include a wearing detection sensor 311 for determining whether the first electronic device 301 is worn on a part (e.g., an ear) of a user's body, and/or an utterance detection sensor 312 for determining whether the user wearing the first electronic device 301 generates an utterance. The audio module 321 may include a first microphone 322 for acquiring an audio signal (e.g., a vocal sound, a voice signal, voice data, a noise signal, or noise data) from an external environment, and a first speaker 323 for outputting an audio signal acquired from an external electronic device. In an embodiment, the memory 130 may store voice quality information 330 for comparing and analyzing quality data (e.g., level) of the user’s voice signal, based on the acquired audio signal.

According to an embodiment, the first electronic device 301 and the second electronic device 302 may include a wearable electronic device (e.g., a hearing device, an earphone, a wireless earphone, or a TWS earphone) that can be worn on a part (e.g., an ear) of the user’s body. For example, the first electronic device 301 may include a first TWS earphone worn on the user’s left ear, and the second electronic device 302 may include a second TWS earphone worn on the user’s right ear. The first electronic device 301 and the second electronic device 302 may be operatively and communicatively connected to each other and share data between each other. The first electronic device 301 and the second electronic device 302 may include at least partially similar electronic devices. According to an embodiment, the first electronic device 301 may at least partially control the second electronic device 302. The first electronic device 301 and the second electronic device 302 may transmit and receive a control signal for controlling operations to and from each other. According to an embodiment, the first electronic device 301 may acquire utterance time point-related information in response to a situation in which a user generates an utterance, and may share the utterance time point-related information with the second electronic device 302.

According to an embodiment, the first electronic device 301 and the second electronic device 302 may be operatively and communicatively (e.g., short-range communication, Bluetooth™ (BT) communication, wireless fidelity (Wi-Fi) Direct communication, or infrared data association (IrDA) communication) connected to an external electronic device (not shown) (e.g., a smartphone or a portable terminal device). According to an embodiment, the external electronic device may control at least one of the first electronic device 301 and the second electronic device 302. According to an embodiment, the external electronic device may execute a call connection program to perform a phone call with an external user (e.g., the other party on a call or an electronic device of the other party), and may use the first electronic device 301 and/or the second electronic device 302 as an audio device during the phone call. For example, the external electronic device may perform an operation of acquiring an audio signal (e.g., a user’s voice signal) or outputting an audio signal (e.g., a voice signal of the other party), based on at least one of the first electronic device 301 and/or the second electronic device 302.

According to an embodiment, the processor 120 of the first electronic device 301 may include various processing circuitry and execute a program (e.g., the program 140 of FIG. 1 or a call connection program) stored in the memory 130 to control at least one other component (e.g., a hardware and/or software component) and perform various data processing or operations. According to an embodiment, the processor 120 may be operatively, functionally, and/or electrically connected to the memory 130, the sensor module 176, the audio module 321, and/or the communication circuit 391.

According to an embodiment, the sensor module 176 of the first electronic device 301 may include various sensors, including, for example, a wearing detection sensor 311 for determining whether the first electronic device 301 is worn on a user’s body part, and/or an utterance detection sensor 312 for determining whether the user wearing the first electronic device 301 is generating an utterance. For example, the wearing detection sensor 311 may include at least one of a touch sensor for detecting whether the first electronic device 301 has been physically contacted with the skin, a gyro sensor for identifying the posture, position, location, and direction of the first electronic device 301, and an acceleration sensor for identifying the movement of the first electronic device 301. The processor 120 of the first electronic device 301 may determine, using the wearing detection sensor 311, whether the first electronic device 301 has been worn on a part of a human body according to a predetermined condition. For example, the utterance detection sensor 312 may include a sensor (e.g., a voice pick-up unit (VPU)) for detecting a vibration generated according to a situation in which a user generates an utterance. For example, the utterance detection sensor 312 may detect a generated tremor (e.g., vibration) of a part (e.g., skin) of the human body in a situation in which a user generates an utterance. The processor 120 may determine that the user generates an utterance, based on the tremor detected by the utterance detection sensor 312. The processor 120 of the first electronic device 301 may determine, using the utterance detection sensor 312, whether the user generates an utterance. The processor 120 may identify that the user’s biometric information has changed, in response to the situation in which the user generates an utterance, and may determine that the user is generating an utterance. The processor 120 may identify a first time point at which the utterance has begun, in response to a situation in which the user generates an utterance.

According to an embodiment, an audio module 321 of a first electronic device 301 may include various audio circuitry, including, for example, a first microphone 322 for acquiring an audio signal (e.g., a voice signal and/or a noise signal) generated in an external environment, and a first speaker 323 for outputting an audio signal (e.g., a voice signal of the other party on a call, and/or voice data) received from an external electronic device (e.g., an electronic device of the other party on a call).

The processor 120 of the first electronic device 301 may at least partially activate the first microphone 322 to acquire an audio signal. For example, the processor 120 may activate the first microphone 322 in response to a situation in which the user generates an utterance, and may analyze an audio signal acquired through the first microphone 322. The processor 120 may distinguish, based on the acquired audio signal, the user's voice signal and the external environment’s noise signal, and store and manage the same individually. According to an embodiment, the processor 120 may calculate, based on the acquired audio signal, signal to noise ratio (SNR) information (e.g., a signal-to-noise ratio, a signal level, a noise level, a ratio of a voice signal to an audio signal, or a ratio of a non-voice signal, which is not a noise signal, to an audio signal), and may identify voice quality information according to the user’s voice, based on the SNR information. For example, when the SNR information is relatively high, it may indicate that the ratio of the voice signal to the noise signal is high, and may indicate that the voice quality is excellent. As another example, when the SNR information is relatively low, it may indicate that the ratio of the voice signal to the noise signal is low, and may indicate that the voice quality is deteriorated. According to an embodiment, the processor 120 may compare the quality of the audio signal acquired through the first microphone 322, based on the voice quality information 330 stored in the memory 130, and may determine whether the quality of the audio signal is relatively good or bad.

The processor 120 of the first electronic device 301 may at least partially activate the first speaker 323 to output an audio signal. For example, the processor 120 may receive an audio signal for the other party on a phone call during the phone call, and may at least partially activate the first speaker 323 to output the received audio signal.

According to an embodiment, the processor 120 may calculate first voice quality information (e.g., first SNR information) corresponding to the audio signal acquired through the first electronic device 301, and calculate second voice quality information (e.g., second SNR information) corresponding to the audio signal acquired through the second electronic device 302. The processor 120 may compare or analyze the first voice quality information and the second voice quality information, and select an electronic device having a relatively better voice quality. For example, the processor 120 may compare first signal to noise ratio (SNR) information corresponding to the first voice quality information and second SNR information corresponding to the second voice quality information, and select an electronic device having a relatively higher calculated value. For example, the SNR information may include at least one of a signal-to-noise ratio, a signal level, a noise level, a ratio of a voice signal to an audio signal, or a ratio of a non-noise signal, which is not a noise signal, to an audio signal. In an embodiment, the processor 120 may partially or completely activate a microphone of the selected electronic device, and may acquire a user’s sound signal having a relatively better voice quality.

According to an embodiment, the communication circuit 391 of the first electronic device 301 may perform communication connection with the second electronic device 302. For example, the first electronic device 301 may be communicatively connected to the second electronic device 302 through the communication circuit 391 according to various communication schemes (e.g., a wired communication channel or a wireless communication channel). According to an embodiment, the communication circuit 391 may include a first sub-communication circuit for supporting communication connection based on the first network 198 of FIG. 1 and a second sub-communication circuit for supporting communication connection based on the second network 199 of FIG. 1. For example, the first electronic device 301 may be communicatively connected to the second electronic device 302 (e.g., an earphone, a wireless earphone, or a TWS earphone) through the first sub-communication module, and may connected for a phone call with an external electronic device (e.g., a smartphone or a portable terminal device) through the second sub-communication module.

According to an embodiment, while being connected for a call with an external electronic device, the first electronic device 301 may perform a communication connection (e.g., a BT communication connection) with the second electronic device 302, and may select a microphone having a relatively better voice quality between the first microphone 322 of the first electronic device 301 and a second microphone 372 of the second electronic device 302. The first electronic device 301 may acquire an audio signal having a relatively better voice quality using the selected microphone.

The second electronic device 302 of FIG. 3 may include at least some elements that are similar to those of the first electronic device 301. Referring to FIG. 3, for example, a second electronic device (for example, the second electronic device 202 of FIG. 2) may include a processor (e.g., including processing circuitry) 370, an audio module (e.g., including audio circuitry) 371, a sensor module (e.g., including at least one sensor) 376, memory 340, and/or a communication circuit 392. For example, the sensor module 376 may include a wearing detection sensor 377 for determining whether the second electronic device 302 is worn on a part (e.g., an ear) of a user’s body. The audio module 371 may include a second microphone 372 for acquiring an audio signal (e.g., a vocal sound, a voice signal, voice data, a noise signal, or noise data) of the external environment, and/or a second speaker 373 for outputting an audio signal acquired from the external electronic device. Comparing the elements included in the second electronic device 302 and the elements included in the first electronic device 301, the sensor module 372 of the second electronic device 302 does not include an utterance detection sensor (not shown), but is not limited thereto. For example, the second electronic device 302 may include an utterance detection sensor.

According to an embodiment, the first electronic device 301 and the second electronic device 302 may include a wearable electronic device (e.g., a TWS earphone) which can be worn on a part (e.g., an ear) of the user's body. For example, when the first electronic device 301 is worn in the left ear, the second electronic device 302 may be worn in the right ear. According to an embodiment, the first electronic device 301 and the second electronic device 302 may transmit and receive data (e.g., utterance time port-related information) and control signals to and from each other in a state of being operatively connected to each other. For example, the first electronic device 301 may use the wearing detection sensor 311 to determine whether the first electronic device 301 has been worn on a part of a human body. The second electronic device 302 may use the wearing detection sensor 377 to determine whether the second electronic device 302 has been worn on a part of a human body.

According to an embodiment, the sensor module 376 of the second electronic device 302 may include various sensors including, for example, a wearing detection sensor 377 for determining whether the second electronic device 302 is worn on a user's body part. For example, the wearing detection sensor 377 may include at least one of a touch sensor for detecting whether the second electronic device 302 is physically contacted with the skin, a gyro sensor for identifying the posture, position, location, and direction of the second electronic device 302, and an acceleration sensor for identifying the movement of the second electronic device 302. The processor 370 of the second electronic device 302 may determine, using the wearing detection sensor 377, whether the second electronic device 302 is worn on a part of a human body according to a configured condition.

According to an embodiment, the audio module 371 of the second electronic device 302 may include various audio circuitry, including, for example, a second microphone 372 for acquiring an audio signal (e.g., a voice signal and/or a noise signal) generated in an external environment and a second speaker 373 for outputting an audio signal (e.g., a voice signal of the other party on a call, and voice data) received from an external electronic device (e.g., an electronic device of the other part of a call).

According to an embodiment, the processor 120 of the first electronic device 301 may determine, using the wearing detection sensor 311, whether the first electronic device 301 is worn on a part of a human body. The processor 120 may detect whether the user is generating an utterance, in response to the state in which the first electronic device 301 is worn on a part of a human body. For example, the processor 120 may determine, using the voice detection sensor 312, whether the user generates an utterance, and may acquire information (e.g., utterance time point information) related to a time point at which an utterance starts. The first electronic device 301 may share the utterance time point information with the second electronic device 302. For example, the first electronic device 301 may acquire a first audio signal through the first microphone 322, based on the utterance time point information, and the second electronic device 302 may acquire a second audio signal through the second microphone 372, based on the utterance time point information. The first electronic device 301 may compare voice quality information (e.g., SNR information) for each electronic device, based on the first audio signal and the second audio signal, and may select an electronic device having a relatively better voice quality. According to an embodiment, the processor 120 may identify the quality of the second audio signal acquired through the second microphone 372, based on the voice quality information 341 stored in the memory 340, and may determine whether the quality of the second audio signal is relatively better or worse than the first audio signal. For example, in case that the voice quality of the second audio signal is relatively better than the voice quality of the first audio signal, the first electronic device 301 may select the second microphone 372 of the second electronic device 302, and at least partially control the second electronic device 302 so as to acquire an audio signal using the selected second microphone 372. According to an embodiment, the above-described operations of the first electronic device 301 may be configured to be automatically performed by the first electronic device 301. According to an embodiment, the first electronic device 301 may periodically or aperiodically determine whether the user generates an utterance, and may perform the above-described operations in response to the situation in which the user generates an utterance.

According to an embodiment, the first electronic device 301 may select a microphone through which an audio signal having a relatively better voice quality is acquired among multiple electronic devices, and may acquire an audio signal (e.g., an audio signal having a relatively better voice quality) using the selected microphone. The first electronic device 301 may acquire an audio signal having a relatively better voice quality, based on the selected microphone.

According to various example embodiments, a first electronic device (e.g., the electronic device 101 of FIG. 1, the first electronic device 201 of FIG. 2, and the first electronic device 301 of FIG. 3) may include a wearing detection sensor (e.g., the wearing detection sensor 311 of FIG. 3), an utterance detection sensor (e.g., the utterance detection sensor 312 of FIG. 3), a communication circuit (e.g., the communication circuit 391 of FIG. 3) configured to be communicatively connected to a second electronic device 302, a first microphone (e.g., the first microphone 322 of FIG. 3), memory (e.g., the memory 130 of FIG. 3), and a processor (e.g., the processor 120 of FIG. 3) operatively connected to the wearing detection sensor 311, the utterance detection sensor 312, the communication circuit 391, the first microphone 322, and the memory 130. According to an embodiment, the processor 120 may, in response to a situation in which the first electronic device 301 is worn on a part of a human body, acquire utterance time point information of a user using the utterance detection sensor 312. The processor 120 may share the acquired utterance time point information with the second electronic device 302 through the communication circuit 391. The processor 120 may acquire, based on the utterance time point information, first voice quality information corresponding to the first electronic device 301 and second voice quality information corresponding to the second electronic device 302. The processor 120 may select one of the first electronic device 301 and the second electronic device 302, based on the first voice quality information and the second voice quality information. The processor 120 may select the first microphone 322 of the first electronic device 301 in case that the first electronic device 301 is selected.

According to an embodiment, the processor 120 may, in a situation in which the first electronic device 301 and the second electronic device 302 are worn on a part of a human body, identify a situation in which the second electronic device 302 is removed from the part of the human body. The processor 120 may, in response to the removal of the second electronic device 302 from the part of the human body, share the utterance time point information of the user with the second electronic device 302.

According to an embodiment, the processor 120 may acquire the first voice quality information corresponding to the first electronic device 301 in a situation in which the first electronic device 301 is worn on a part of a human body. The processor 120 may, in response to a situation in which the first voice quality information has a value equal to or smaller than a configured threshold value, acquire the utterance time point information of the user.

According to an embodiment, the processor 120 may detect, using the utterance detection sensor 312, vibration according to utterance of the user. The processor 120 may acquire, based on information on the detected vibration, the utterance time point information.

According to an embodiment, the process 120 may suspend reception of a voice signal through a second microphone 372 included in the second electronic device 302 in case that the first electronic device 301 is selected.

According to an embodiment, the processor 120 may select a second microphone 372 of the second electronic device 302 in case that the second electronic device 302 is selected based on the first voice quality information and the second voice quality information.

According to an embodiment, the processor 120 may, in response to the selection of the second microphone 372 of the second electronic device 302, suspend reception of a voice signal through the first microphone 322 of the first electronic device 301. The processor 120 may maintain output of an audio signal through the first electronic device 301.

According to an embodiment, the processor 120 may transmit at least one packet including the utterance time point information to the second electronic device 302 through the communication circuit 391.

According to an embodiment, the processor 120 may identify a third electronic device 303 operatively connected through the communication circuit 391 and not worn on a part of a human body. The processor 120 may calculate a distance spaced apart from the third electronic device 303. The processor 120 share the utterance time point information with the third electronic device 303 in case that the calculated distance is identified to be within a configured threshold distance. The processor 120 may acquire, based on the utterance time point information, first voice quality information corresponding to the first electronic device 301 and third voice quality information corresponding to the third electronic device 303. The processor 120 may select one of the first electronic device 301 and the third electronic device 303, based on the first voice quality information and the third voice quality information. The processor 120 may select a microphone included in the third electronic device 303 in case that the third electronic device 303 is selected.

According to an embodiment, the processor 120 acquire, from the communicatively connected third electronic device 303, information related to proximity to the third electronic device 303. The processor 120 may, in response to a situation in which the third electronic device 303 is in proximity, share the utterance time point information with the third electronic device 303.

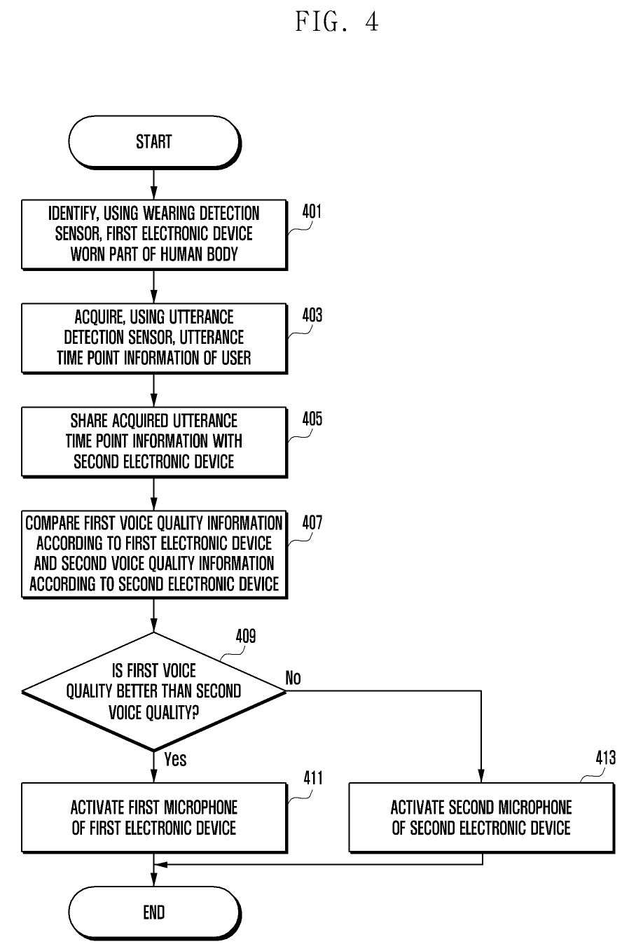

FIG. 4 is a flowchart illustrating an example method of comparing voice qualities corresponding to multiple microphones, respectively, and selecting a microphone having a relatively better voice quality according to various example embodiments.

In the various example embodiments below, the operations may be sequentially performed, but are not necessarily sequentially performed. For example, the order of the operations may be changed, and at least two operations may be performed in parallel.

A first electronic device 301 of FIG. 4 may be at least partially similar to the electronic device 101 of FIG. 1, the first electronic device 201 of FIG. 2, and/or the first electronic device 301 of FIG. 3, or may further include various embodiments of the electronic device 101. The second electronic device 302 of FIG. 4 may be at least partially similar to the electronic devices 102 and 104 of FIG. 1, the second electronic device 202 of FIG. 2, and/or the second electronic device 302 of FIG. 3, and may further include various embodiments of the second electronic device 302.

In operation 401, a processor (e.g., the processor 120 of FIG. 3) of the first electronic device 301 may identify, using a wearing detection sensor (e.g., the wearing detection sensor 311 of FIG. 3), the first electronic device 301 worn on a part (e.g., an ear) of a human body. For example, the first electronic device 301 may be in a state being connected to the second electronic device 302 through wired communication or wireless communication. The first electronic device 301 and the second electronic device 302 may include a wearable electronic device (e.g., a TWS earphone) which can be worn on a part (e.g., an ear) of a user’s body. In operation 401, an external electronic device (e.g., a smartphone or a portable terminal device) operatively communicatively connected to the first electronic device 301 and/or the second electronic device 302 may be in a state of performing a phone call with another electronic device. The first electronic device 301 and/or the second electronic device 302 may operate as an audio device (e.g., an audio signal input device and/or an audio signal output device) for an external electronic device. According to an embodiment, in a state in which the first electronic device 301 has been worn on a part of a human body, the second electronic device 302 may be in a state being released from the part of the human body.

In operation 403, the processor 120 of the first electronic device 301 may acquire the user’s utterance time point information using the utterance detection sensor (e.g., the utterance detection sensor 312 of FIG. 3). For example, the processor 120 may activate the utterance detection sensor 312 in response to the state in which the first electronic device 301 is worn on the part of the human body, and may acquire information (e.g., utterance time point information) related to an utterance time point, in response to a situation in which a user generates an utterance. For example, the utterance detection sensor 312 may detect a vibration (e.g., tremor) generated in a situation where the user generates an utterance, and in response to the detection of the vibration, determine that the user is generating an utterance. The processor 120 may identify the user’s utterance time point.

In operation 405, the processor 120 may share the acquired utterance time point information with the second electronic device 302. For example, the first electronic device 301 may transmit the utterance time point information to the second electronic device 302 operatively and communicatively connected thereto. If the first electronic device 301 and the second electronic device 302 are connected through Bluetooth™ (BT) communication, the first electronic device 301 may generate a BT packet including the utterance time point information, and may transmit the BT packet to the second electronic device 302.

In operation 407, the processor 120 may compare first voice quality information according to the first electronic device 301 and second voice quality information according to the second electronic device 302. For example, in operation 405, the first electronic device 301 may acquire a first audio signal through the first microphone 322, based on the shared utterance time point information. The first audio signal may include a voice signal generated by the user and a noise signal from the surrounding environment while the user is generating an utterance. The processor 120 may calculate, based on the acquired first audio signal, first SNR information (e.g., a signal to noise ratio, a ratio of a voice signal to the first audio signal, or a ratio of the other audio signal, which is not a noise signal, to the first audio signal). The first SNR information may indicate a ratio of a voice signal to the first audio signal, and may include data obtained by converting the first voice quality information into a numerical value. For example, the second electronic device 302 may acquire a second audio signal through the second microphone 372, based on the shared utterance time point information, in operation 405. The second audio signal may include a voice signal generated by the user and a noise signal in the surrounding environment while the user is generating an utterance. The processor 120 may calculate second SNR information (e.g., a signal-to-noise ratio, a ratio of a voice signal to the second audio signal, or a ratio of the other voice signal, which is not a noise signal, to the second audio signal), based on the acquired second audio signal. The second SNR information may indicate a ratio of a voice signal to the second audio signal, and may include data obtained by converting the second voice quality information into a numerical value. According to an embodiment, the second electronic device 302 may calculate second SNR information, based on the utterance time point information, and may transmit the second SNR information to the first electronic device 301.

In operation 407, the comparing of the first voice quality information and the second voice quality information may include comparing the first SNR information and the second SNR information. In an embodiment, the processor 120 of the first electronic device 301 may determine an audio signal having a relatively better voice quality, based on the first SNR information (e.g., voice quality information of the first audio signal acquired through the first microphone 322) and the second SNR information (e.g., voice quality information of the second audio signal acquired through the second microphone 372). For example, when acquiring an audio signal, it may be determined whether the voice quality of the first audio signal, which is based on the first microphone 322, is better, or the voice quality of the second audio signal, which is based on the second microphone 372, is better. According to an embodiment, when the SNR information (the ratio of the audio signal to the ambient noise signal) is high, it may indicate that the ratio of the voice signal to the audio signal is large, and may also indicate that the voice quality is relatively better. According to an embodiment, when the SNR information is low may, it may indicate that the ratio of the voice signal to the audio signal is small, and may indicate that the voice quality is relatively low.

In operation 409, the processor 120 may determine whether a first voice quality (e.g., voice quality for the first audio signal) is better than a second voice quality (e.g., voice quality for the second audio signal). For example, when the first voice quality is better than the second voice quality, it may indicate that acquiring a first audio signal using the first microphone 322 is better at acquiring an audio signal having a relatively better voice quality than acquiring a second audio signal using the second microphone 372. According to an embodiment, the first electronic device 301 may acquire an audio signal having a relatively better voice quality, and may provide an audio signal having a better voice quality to a user.

When the first voice quality is better than the second voice quality in operation 409, the processor 120 may select the first microphone 322 of the first electronic device 301 in operation 411. For example, in operation 411, the processor 120 may deactivate the second microphone 372 of the second electronic device 302 while selecting the first microphone 322.

When the second voice quality is better than the first voice quality in operation 409, the processor 120 may select the second microphone 372 of the second electronic device 302 in operation 413. For example, in operation 413, the processor 120 may deactivate the first microphone 322 of the first electronic device 301 while selecting the second microphone 372.

According to an embodiment, the processor 120 of the first electronic device 301 may determine, using the wearing detection sensor 311, whether the first electronic device 301 is worn on a part of a human body. The processor 120 may detect whether the user is generating an utterance, in response to the state in which the first electronic device 301 is worn on the part of the human body. For example, the processor 120 may determine, using the utterance detection sensor 312, whether the user has generated an utterance, and may acquire information (e.g., utterance time point information) related to a time point at which an utterance starts. The first electronic device 301 may share the utterance time point information with the second electronic device 302. For example, the first electronic device 301 may acquire a first audio signal through the first microphone 322, based on the utterance time point information, and the second electronic device 302 may acquire a second audio signal through the second microphone 372, based on the utterance time point information. The first electronic device 301 may compare the voice quality information (e.g., SNR information) for each electronic device, based on the first audio signal and the second audio signal, and may select an electronic device having a relatively better voice quality. For example, the first electronic device 301 may compare and analyze first voice quality information corresponding to the first audio signal and second voice quality information corresponding to the second audio signal. For example, when the second voice quality information is relatively better than the first voice quality information, the first electronic device 301 may select the second microphone 372 of the second electronic device 302, and at least partially control the second electronic device 302 such that the second microphone 372 is activated. As another example, when the first voice quality information is relatively better than the second voice quality information, the first electronic device 301 may select the first microphone 322, and may activate the first microphone 322.

According to an embodiment, the first electronic device 301 may be configured such that the above-described operations (for example, operations 401 to 413) are automatically performed. According to an embodiment, while the first electronic device 301 has been worn on a part of a human body, the first electronic device 301 may periodically or aperiodically identify whether a user generates an utterance, and may perform operations 405 to 413 in response to a situation in which the user generates an utterance.

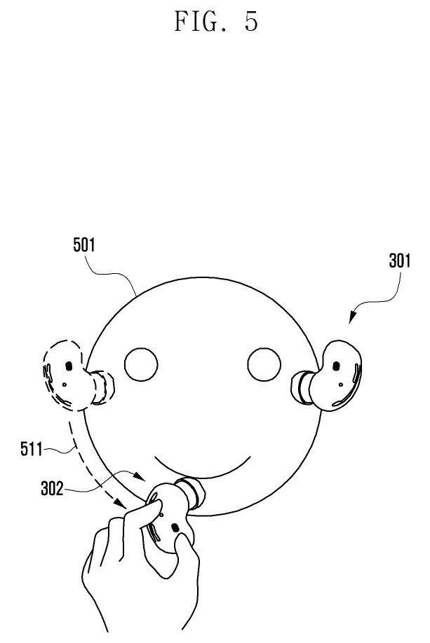

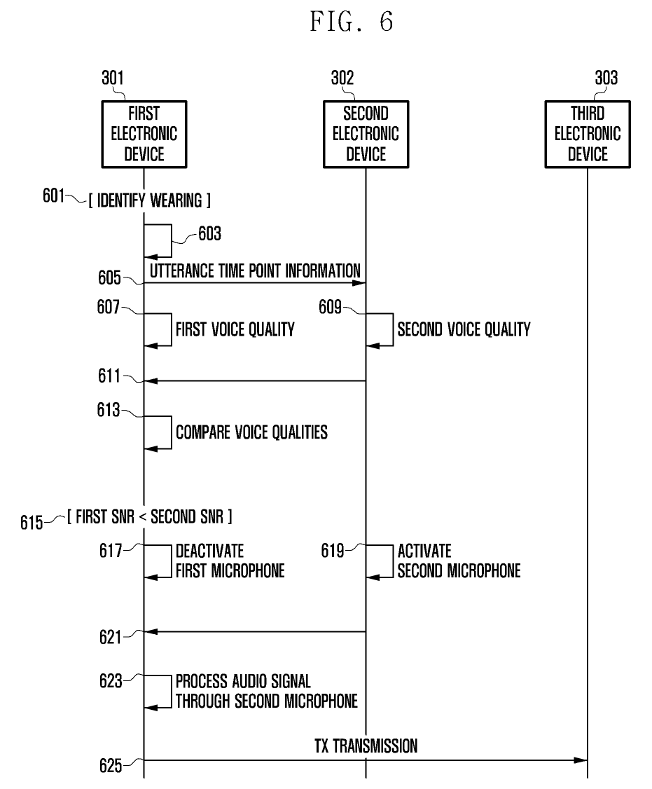

FIG. 5 is a diagram illustrating that a first electronic device performs a call using a microphone of a second electronic device while the first electronic device is worn on a part of a human body, according to various example embodiments. FIG. 6 is a signal flow diagram illustrating an example operation in which a call is performed based on a microphone of a second electronic device while a first electronic device is worn on a part of a human body, according to various example embodiments.

Electronic devices 301 and 302 illustrated in FIGS. 5 and 6 may be at least partially similar to the electronic device 101 of FIG. 1, the electronic devices 201 and 202 of FIG. 2, and the first electronic device 301 and/or the second electronic device 302 of FIG. 3, or may further include various embodiments of the electronic device 101. The electronic devices 301 and 302 illustrated in FIG. 5 may include a wireless earphone corresponding to a wearable electronic device. The electronic device 301 or 302 may be at least partially worn on a part (e.g., an ear) of a user 501’s body. The electronic devices 301 and 302 may include a first electronic device 301 worn on the left ear of the user 501 and a second electronic device 302 worn on the right ear of the user 501.

Referring to FIG. 5, an operation 511 in which the user 501 holds the second electronic device 302 and bring the same near the user 501’s mouth while the first electronic device 301 is worn on a part (e.g., an ear) of the user 501’s body between the electronic devices (301 and 320) is illustrated. For example, it may be the operation 511 in which when the user 501 performs a phone call using an external electronic device (e.g., a third electronic device 303 of FIG. 6) connected to the electronic devices 301 and 302 via wired or wireless communication, the user brings the second electronic device 302 near his or her mouth so that the user’s voice is more accurately transferred to the other party. For example, the operation 511 in which the user 501 moves the second electronic device 302 (e.g., a microphone of the second electronic device 302) near his or her mouth so that the user’s voice is more accurately transferred to the other party in an environment in which a high level of ambient noise is generated may be performed.

Referring to FIG. 6, an electronic device (e.g., a hearing device, an earphone, a wireless earphone, a TWS earphone, or a wearable electronic device) (e.g., the first electronic device 301 or the second electronic device 302) which can be worn on a part (e.g., an ear) of the user 501’s body may be operatively and communicatively (e.g., short-range communication, Bluetooth™ (BT) communication, wireless fidelity (Wi-Fi) Direct communication, or infrared data association (IrDA) communication) connected to an external electronic device (e.g., a smartphone or a portable terminal device) (e.g., the third electronic device 303). For example, the wearable electronic devices 301 and 302 may include at least one of a wireless earphone, a wired earphone, and/or a headset which can be worn on the user 501’s ear. The wearable electronic device 301 and 302 may function as a speaker for providing an audio service (e.g., a music service) to the user 501, or may function as a mic (e.g., a microphone) for acquiring the user 501’s voice (e.g., a sound source, an audio signal, voice data, or utterance data). For example, the wearable electronic devices 301 and 302 may include at least one speaker and at least one microphone. For example, the wearable electronic devices 301 and 302 may be worn on a part (e.g., the ear or the earlobe) of the user 501’s body, and may include a wearing detection sensor (e.g., the wearing detection sensor 311 of FIG. 3) for determining whether the wearable electronic devices 301 and 302 are worn on the part of the human body, and an utterance detection sensor (e.g., the utterance detection sensor 312 of FIG. 3) for determining whether the user 501 is generating an utterance.

Referring to FIG. 6, in operation 601, the first electronic device 301 may identify, using the wearing detection sensor 311, whether the first electronic device 301 is worn on a part of the user 501’s body.

In operation 603, in case that it is identified that the first electronic device 301 is worn, the first electronic device 301 may acquire, using the ignition detection sensor 312, information (e.g., utterance time point information) related to a time point at which the user 501 generates an utterance. For example, when the wearing of the first electronic device 301 is identified, the first electronic device 301 may partially activate the utterance detection sensor 312, and may acquire the user’s utterance time point information using the activated utterance detection sensor 312. According to an embodiment, in relation to an audio signal acquired from an external environment, when whether the user’s voice signal is included in the audio signal is identified, a voice signal having a better voice quality may be extracted. For example, if whether the audio signal includes a user’s voice signal and a noise signal or only includes a noise signal can be identified, the first electronic device 301 may more accurately measure voice quality of the audio signal. For example, in relation to audio signals acquired by multiple electronic devices, respectively, when the voice qualities of the respective audio signals are compared, the reliability can be enhanced.

According to an embodiment, the first electronic device 301 may determine whether the second electronic device 302 is worn on a part of the user 501 s’ body in a state in which the wearing of the first electronic device 301 is identified, and in response to a situation in which the second electronic device 302 is removed from the part of the body, the first electronic device may acquire the user 501’s utterance time point information using the utterance detection sensor 312. An embodiment may include a situation in which the user holds the second electronic device 302 with his or her hand and bring the same near his or her mouth in a state in which both the first electronic device 301 and the second electronic device 302 are worn on a part of the user 501’s body. According to an embodiment, in a state in which the first electronic device 301 is worn, in response to a situation in which the wearing of the second electronic device 302 is released, the first electronic device 301 may activate the utterance detection sensor 312 in order to acquire utterance time point information.

According to an embodiment, the first electronic device 301 may calculate voice quality information (e.g., SNR information) based on the first electronic device 301 in a state in which the wearing of the first electronic device 301 is identified, and determine whether the calculated voice quality information drops to a value equal to or smaller than a configured threshold. In response to a situation in which the calculated voice quality information drops to a value equal to or smaller than the configured threshold, the first electronic device 301 may acquire the user 501’s utterance time point information. According to an embodiment, the first electronic device 301 may detect a situation in which the voice quality is degraded (for example, a situation in which the voice quality is degraded because the level of ambient noise is high). The first electronic device 301 may acquire, in response to the situation in which the voice quality drops to a value equal to or smaller than the configured threshold, the user 501’s utterance time point information. According to an embodiment, the first electronic device 301 may acquire a voice signal having a relatively better voice quality using the acquired utterance time point information. The first electronic device 301 may perform a phone call service, based on the voice signal having a better voice quality, and user satisfaction according to the phone call service can be improved.

According to an embodiment, the first electronic device 301 may detect a specific situation (e.g., a situation in which the level of ambient noise is high and the voice quality of the user’s voice signal is deteriorated). In response to detecting the specific situation, the first electronic device 301 may share the utterance time point information with at least one other electronic device in order to acquire an audio signal having a relatively better voice quality. For example, the first electronic device 301 may compare or analyze the voice qualities of audio signals acquired by respective electronic devices, based on the shared utterance time point information.

In operation 605, the first electronic device 301 may share the acquired utterance time point information with the second electronic device 302.

In operation 607, the first electronic device 301 may calculate a first voice quality (e.g., first SNR information) corresponding to an audio signal acquired through a first microphone (e.g., the first microphone 322 of FIG. 3) of the first electronic device 301, based on the utterance time point information.

In operation 609, the second electronic device 302 may calculate a second voice quality (e.g., second SNR information) corresponding to an audio signal acquired through a second microphone (e.g., the first microphone 372 of FIG. 3) of the second electronic device 302, based on the utterance time point information. For example, the information indicating the voice quality may include signal to noise ratio (SNR) information (e.g., a signal-to-noise ratio, a ratio of a voice signal to an audio signal, or a ratio of the other voice signal, which is not a noise signal, to an audio signal).

In operation 611, the second electronic device 302 may transmit the calculated second voice quality to the first electronic device 301. For example, the first electronic device 301 may request the second electronic device 302 for information related to the second voice quality, and the second electronic device 302 may transmit the information related to the second voice quality to the first electronic device 301 as a response signal to the request.

In operation 613, the first electronic device 301 may compare and analyze the first voice quality and the second voice quality. For example, when the second voice quality is better than the first voice quality, it may indicate that, in a substantially identical surrounding environment, the voice quality of an audio signal received through the second microphone 377 is relatively better.

In operation 615, the first electronic device 301 may determine that the second SNR information (e.g., the second voice quality) is relatively higher than the first SNR information (e.g., the first voice quality). According to an embodiment, the first electronic device 301 may compare the first SNR information and the second SNR information, and may select an electronic device having a relatively better voice quality. Operation 615 of FIG. 6 may be based on the assumption that the voice quality of the audio signal acquired by the second electronic device 302 is relatively higher. Operations 617 to 619 may be operations performed in consideration of a situation in which the second SNR information is relatively higher than the first SNR information. Operations 617 and 619 may be example operations performed in a situation in which the second SNR information is higher than the first SNR information.

In operation 617, the first electronic device 301 may at least partially deactivate the first microphone 322 of the first electronic device 301, and may suspend a function of acquiring an audio signal, based on the first microphone 322. For example, while suspending the function of acquiring an audio signal (e.g., a user’s voice signal) through the first microphone 322, the first electronic device 301 may maintain the function of outputting an audio signal (e.g., an audio signal provided from the third electronic device 303) using the first speaker 323. For example, the first electronic device 301 may suspend an audio acquisition function related to the first microphone 322, and maintain an audio output function related to the first speaker 323.

In operation 619, the second electronic device 302 may at least partially activate the second microphone 372 of the second electronic device 302, and may maintain a function of acquiring an audio signal, based on the second microphone 372. For example, if the second microphone 372 has been previously activated, the second electronic device 302 may maintain the activation of the second microphone 372. For example, while maintaining the function of acquiring an audio signal (e.g., a user's voice signal) through the second microphone 372, the second electronic device 302 may suspend the function of outputting an audio signal using the second speaker 373. For example, the second electronic device 302 may maintain an audio acquisition function related to the second microphone 372, and may suspend an audio output function related to the second speaker 373. For example, the second electronic device 302 may be in a state of being hold by the user and moved near the user’s mouth.

According to an embodiment, in operation 617, the first electronic device 301 may perform an audio output function related to the first speaker 323, and in operation 619, the second electronic device 302 may perform an audio acquisition function related to the second microphone 372.

In operation 621, the second electronic device 302 may acquire an audio signal using the activated second microphone 372, and may transmit the acquired audio signal to the first electronic device 301.

In operation 623, the first electronic device 301 may process an audio signal according to a transmission-related function (e.g., an audio signal received from the second electronic device 302) and an audio signal according to a reception-related function (e.g., an audio signal received from an external electronic device).

In operation 625, the first electronic device 301 may transmit the processed audio signal (e.g., the audio signal received from the second electronic device 302) to an external electronic device (e.g., the third electronic device 303) that is in a phone call.

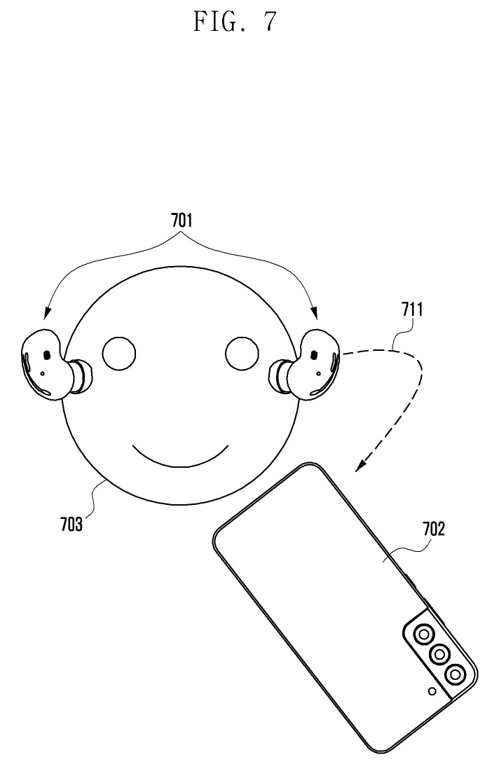

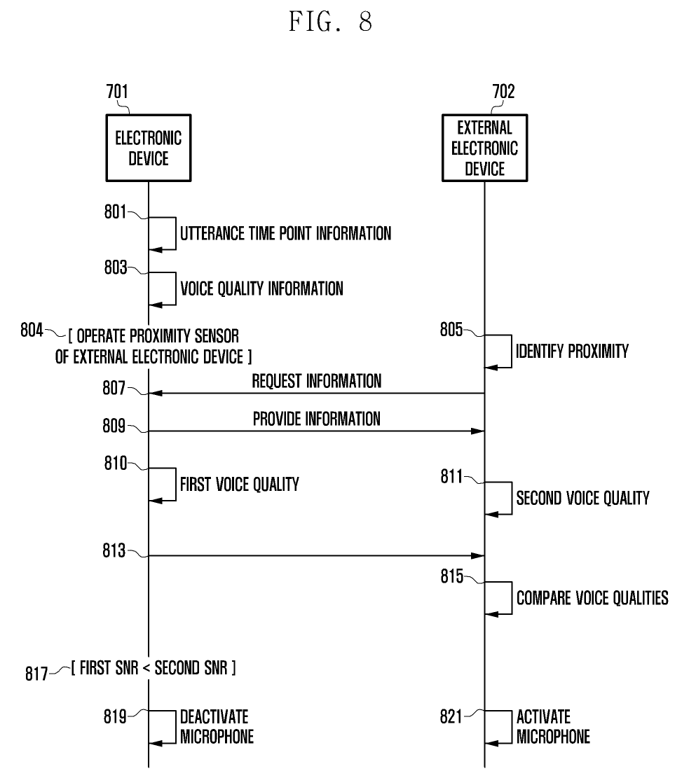

FIG. 7 is a diagram illustrating that a wearable electronic device performs a call using a microphone of an external electronic device while being worn on a part of a human body, according to various example embodiments. FIG. 8 is a signal flow diagram illustrating an example operation in which while a wearable electronic device is worn on a part of a human body, a call is performed based on a microphone of an external electronic device, according to various example embodiments.

An electronic device 701 illustrated in FIGS. 7 and 8 may be at least partially similar to the electronic device 101 of FIG. 1, the electronic devices 201 and 202 of FIG. 2, and the first electronic device 301 and/or the second electronic device 302 of FIG. 3, or may further include various embodiments of the electronic device 101. The electronic device 701 illustrated in FIG. 7 may include a wireless earphone corresponding to a wearable electronic device. The electronic device 701 may be at least partially worn on a part (e.g., an ear) of a user 703’s body.

Referring to FIG. 7, a situation in which while the electronic device 701 is worn on a part (e.g., an ear) of the user 703’s body, the user 703 holds an external electronic device 702 (e.g., a smartphone or a portable terminal device) and brings the same near the user 703’s mouth is illustrated. For example, the electronic device 701 and the external electronic device 702 may be in a state of being connected to each other via wired communication or wireless communication. Referring to FIG. 7, a situation in which while the external electronic device 702 is connected for a call with another electronic device, an audio function (e.g., a microphone function or a speaker function) by the electronic device 701 is serviced may be illustrated. For example, in an environment in which a high level of ambient noise is generated, an operation 711 in which the user 703 moves the external electronic device 702 (e.g., a microphone of the external electronic device 702) near his or her mouth so that the user’s voice can be more accurately transferred to the other part may be performed.

Referring to FIG. 8, the electronic device 701 (e.g., a hearing device, an earphone, a wireless earphone, a TWS earphone, or a wearable electronic device) which can be worn on a part (e.g., an ear) of the user 703’s body may be operatively and communicatively (e.g., short-range communication, Bluetooth™ (BT) communication, wireless fidelity (Wi-Fi) Direct communication, or infrared data association (IrDA) communication) connected to the external electronic device 702 (e.g., a smartphone or a portable terminal device). For example, the electronic device 701 may include at least one of a wireless earphone, a wired earphone, and/or a headset which can be worn on the user 703’s ear. The electronic device 701 may function as a speaker for providing an audio service (e.g., a music service) to the user 703, or may function as a mic (e.g., a microphone) for acquiring the user 703’s voice (e.g., a sound source, an audio signal, voice data, or utterance data). For example, the electronic device 701 may include at least one speaker and at least one microphone. The electronic device 701 may be worn on a part (e.g., the ear or the earlobe) of the user 703’s body, and may include a wearing detection sensor (e.g., the wearing detection sensor 311 of FIG. 3) for determining whether the electronic device 701 is worn on the part of the human body, and an utterance detection sensor (e.g., the utterance detection sensor 312 of FIG. 3) for determining whether the user 703 is generating an utterance.

According to an embodiment, the electronic device 701 may include a first electronic device (e.g., the first electronic device 301 of FIG. 3) and a second electronic device (e.g., the second electronic device 302 of FIG. 3), which are worn on both ears (e.g., left and right ears) of the user, respectively. For example, the electronic device 701 may configure, as a main microphone (e.g., a microphone for acquiring audio sound in an external environment), one of the first microphone 322 of the first electronic device 301 and the second microphone 372 of the second electronic device 302. Referring to FIGS. 7 and 8, an operation between the electronic device 701 and the external electronic device 702 is described on the assumption that the electronic device 701 has configured the first microphone 322 as a main microphone.

Referring to FIG. 8, in operation 801, the electronic device 701 may identify, using the wearing detection sensor 311, whether the electronic device 701 is worn on a part of the user 703’s body, and when the wearing of the electronic device 701 is identified, may acquire, using the utterance detection sensor 312, information (e.g., utterance time point information) related to a time point at which the user 703 generates an utterance.

In operation 803, the electronic device 701 may calculate, based on the acquired utterance time point information, voice quality information (e.g., SNR information) corresponding to an audio signal acquired through a first microphone (e.g., the first microphone 322 of FIG. 3) of the electronic device 701. For example, the information indicating the voice quality may include signal to noise ratio (SNR) information (e.g., a signal-to-noise ratio, a ratio of a voice signal to an audio signal, or a ratio of the other voice signal, which is not a noise signal, to an audio signal).

In operation 804, the electronic device 701 may operate a proximity sensor of the external electronic device 702 in order to detect a situation in which the external electronic device 702 is proximate to a part (e.g., mouth or ear) of the user 703’s body. For example, the external electronic device 702 may at least partially activate the proximity sensor periodically or aperiodically. According to an embodiment, the external electronic device 702 may determine, based on the strength of a communication signal for the electronic device 701, whether the electronic device 701 is in proximity. For example, when the strength of the communication signal exceeds a threshold value, the external electronic device 702 may determine that the external electronic device 702 and the electronic device 701 are primate to each other within a configured distance (e.g., a configured threshold distance). According to an embodiment, the external electronic device 702 may detect, based on various schemes other than using the proximity sensor, whether the electronic device 701 and the external electronic device 702 are proximate to each other. For example, when the electronic device 701 and the external electronic device 702 are proximate to each other within the configured distance (e.g., the configured threshold distance), it may indicate that the external electronic device 702 is proximate to a part (e.g., mouth or ear) of the user’s body.

In operation 805, the external electronic device 702 may identify, using the proximity sensor, whether the external electronic device 702 is proximate to a part of the user 703’s body. According to an embodiment, the external electronic device 702 may acquire information (e.g., a sensing value by the proximity sensor or signal strength-related information) related to the proximity to the electronic device 701, and determine whether the external electronic device 702 is proximate to the electronic device 701 within the configured distance. For example, when the electronic device 701 and the external electronic device 702 are proximate to each other within the configured distance, it may indicate that the external electronic device 702 is proximate to a part (e.g., mouth or ear) of the user’s body.

In operation 807, in response to a situation in which the external electronic device 702 is proximate to the part of the user 703’s body, the external electronic device 702 may request utterance time point information (e.g., the utterance time point information acquired in operation 801) from the electronic device 701. In an embodiment, operation 807 may be omitted.

In operation 809, in response to an information request signal from the external electronic device 702, the electronic device 701 may provide the utterance time point information to the external electronic device 702. The electronic device 701 may share the utterance time point information with the external electronic device 702. In an embedment, in a case where operation 807 is omitted, when acquiring utterance time point information, the electronic device 701 may transmit the utterance time point information to the external electronic device 702.

In operation 810, the electronic device 701 may calculate, based on the utterance time point information, a first voice quality (e.g., first SNR information) corresponding to an audio signal acquired through a microphone of the electronic device 701.

In operation 811, the external electronic device 702 may calculate, based on the utterance time point information, a second voice quality (e.g., second SNR information) corresponding to an audio signal acquired through a microphone of the external electronic device 702. For example, the information indicating the voice quality may include signal to noise ratio (SNR) information (e.g., a signal-to-noise ratio, a ratio of a voice signal to an audio signal, or a ratio of the other voice signal, which is not a noise signal, to an audio signal).

In operation 813, the electronic device 701 may transmit the calculated first voice quality to the external electronic device 702. For example, the external electronic device 702 may request information related to the first voice quality from the electronic device 701, and the electronic device 701 may transmit the information related to the first voice quality to the external electronic device 702 as a response signal to the request.

In operation 815, the external electronic device 702 may compare and analyze the first voice quality and the second voice quality. For example, when the second voice quality is better than the first voice quality, it may indicate that, in a substantially identical surrounding environment, the voice quality of an audio signal received through the microphone of the external electronic device 702 is relatively better.

In operation 817, the electronic device 701 may determine that the second SNR information (e.g., the second voice quality) is relatively higher than the first SNR information (e.g., the first voice quality). According to an embodiment, the electronic device 701 may compare the first SNR information and the second NSR information, and select an electronic device having a relatively better voice quality. Operation 817 of FIG. 8 may be based on the assumption that the voice quality of the audio signal acquired by the external electronic device 702 is relatively higher. Operations 819 to 821 may be operations performed in consideration of a situation in which the second SNR information is relatively higher than the first SNR information. Operations 819 and 821 may be example operations performed in a situation in which the second SNR information is higher than the first SNR information.

In operation 819, the electronic device 701 may at least partially deactivate the microphone of the electronic device 701, and may suspend a function of acquiring an audio signal, based on the microphone. For example, while suspending a function of acquiring an audio signal (e.g., a user’s voice signal) through the microphone, the electronic device 701 may maintain a function of outing an audio signal (e.g., an audio signal provided by the external electronic device 702) using the speaker. For example, the electronic device 701 may suspend an audio acquisition function related to the microphone, and maintain an audio output function related to the speaker.

In operation 821, the external electronic device 702 may at least partially activate the microphone of the external electronic device 702, and perform a function of acquiring the audio signal, based on the activated microphone. For example, when the microphone has been previously activated, the external electronic device 702 may main the activation of the microphone. For example, while maintaining the function of acquiring the audio signal (e.g., the user’s voice signal) through the microphone, the external electronic device 702 may suspend the function of outputting the audio signal using the speaker. For example, the external electronic device 702 may maintain the audio acquisition function related to the microphone, and may suspend the audio output function related to the speaker. For example, this may correspond to a state in which the external electronic device 702 is moved near the user’s mouth while being held by the user.

According to an embodiment, in operation 819, the electronic device 701 (e.g., a wearable electronic device) may perform the audio output function related to the speaker, and in operation 821, the external electronic device 702 (e.g., a smartphone) may perform the audio acquisition function related to the microphone. According to operations 819 and 821, it may be determined that the microphone of the external electronic device 702 is selected between the microphone of the electronic device 701 and the microphone of the external electronic device 702. According to an embodiment, the electronic device 701 may select a microphone which is identified to have a relatively higher voice quality of an audio signal.

According to an embodiment, the external electronic device 702 may perform a call function with another electronic device, based on the audio acquisition function by the microphone and the audio output function by the speaker of the electronic device 701.

According to an embodiment, the electronic device 701 may identify another electronic device (e.g., another electronic device including a microphone) operatively connected to the electronic device 701, and may calculate a distance spaced apart from the identified other electronic device. For example, the electronic device 701 may determine, based on the strength of a communication signal with the other electronic device, whether the other electronic device is proximate within a configured distance. When it is identified that the other electronic device is proximate within the configured distance, the electronic device 701 may share utterance time point information with the other electronic device. The electronic device 701 may individually acquire, based on the shared utterance time point information, a first audio signal through the electronic device 701 and a second audio signal through the other electronic device. The electronic device 701 may compare first voice quality information for the first audio signal and second voice quality information for the second audio signal, and may select a device by which an audio signal having a relatively better voice quality is acquired. According to an embodiment, the electronic device 701 may recognize the other electronic device around the electronic device 701, and select an electronic device for acquiring an audio signal having a relatively better quality. According to an embodiment, the electronic device 701 may select a microphone for acquiring an audio signal having a relatively better quality, and acquire an ambient audio signal, based on the selected microphone.

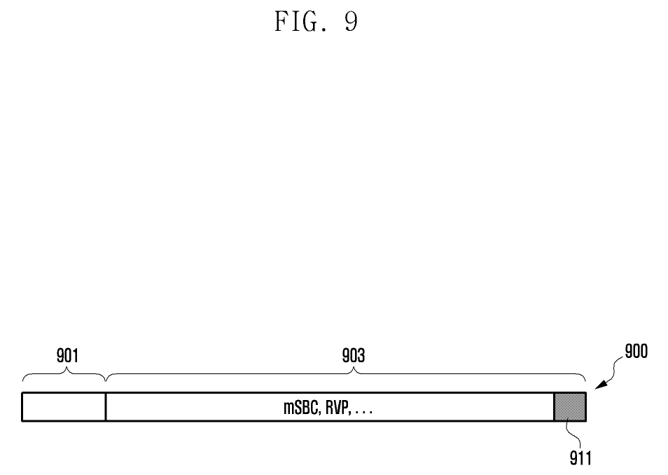

FIG. 9 is a diagram illustrating an example configuration of data shared between a first electronic device and a second electronic device according to various example embodiments.

According to an embodiment, the first electronic device (e.g., the first electronic device 301 of FIG. 3) and the second electronic device (e.g., the second electronic device 302 of FIG. 3) may include a wireless earphone corresponding to a wearable electronic device. For example, the first electronic device 301 may include a wireless earphone worn on the left ear of a user, and the second electronic device 302 may include a wireless earphone worn on the right ear of the user. The first electronic device 301 and the second electronic device 302 may be in a state of being operatively and communicatively (e.g., Bluetooth™ (BT) communication) connected, and may transmit and receive BT packets 900 to and from each other. According to an embodiment, the first electronic device 301 and the second electronic device 302 may implement, in the form of a 2-bit package 911, information (e.g., utterance time point information) related to an utterance time point and information (e.g., voice quality information) related to voice quality, and may store the 2-bit package 911 in a payload 903 in the BT packet 900. Referring to FIG. 5 and FIG. 6, the first electronic device 301 and the second electronic device 302 may transmit or receive data, based on the BT packet 900.

According to an embodiment, the first electronic device may include a wearable electronic device (e.g., the electronic device 701 of FIGS. 7 and 8), and the second electronic device may include an external electronic device (e.g., the external electronic device 702 of FIGS. 7 and 8). Referring to FIGS. 7 and 8, the electronic device 701 and the external electronic device 702 may transmit or receive data, based on the BT packet 900.

Referring to FIG. 9, a structure of the BT packet 900 is illustrated. For example, the BT packet 900 may be a data block, and may include a header 901 and a payload 903. For example, the header 901 is a data area located at the front of the data block, and may include supplementary data. The payload 903 is a data area remaining after excluding the header 901 from the data block, and may include the main data (e.g., mSBC or RVP) of the BT packet 900. According to an embodiment, the utterance time point information and the voice quality information may be stored, in the form of a package, in the payload 903 of the BT packet 900.

According to an embodiment, the first electronic device 301 and the second electronic device 302 may share the utterance time point information and the voice quality information included in the BT packet 900 with each other. The first electronic device 301 and the second electronic device 302 may periodically or aperiodically transmit and receive a small capacity of data, such as in the BT packet 900, and may more easily share the utterance time information.

A method for selecting a microphone according to various example embodiments may include in response to a situation in which a first electronic device 301 is worn on a part of a human body, acquiring utterance time point information of a user using an utterance detection sensor 312 of the first electronic device 301, sharing the acquired utterance time point information with a second electronic device 302 operatively and communicatively connected to the first electronic device 301, acquiring, based on the utterance time point information, first voice quality information corresponding to the first electronic device 301 and second voice quality information corresponding to the second electronic device 302, selecting one of the first electronic device 301 and the second electronic device 302, based on the first voice quality information and the second voice quality information, and in case that the first electronic device 301 is selected, selecting a first microphone 322 of the first electronic device 301.

According to an example embodiment, the sharing of the utterance time point information may include in a situation in which the first electronic device 301 and the second electronic device 302 are worn on a part of a human body, identifying a situation in which the second electronic device 302 is removed from the part of the human body, and in response to the removal of the second electronic device 302 from the part of the human body, sharing the utterance time point information of the user with the second electronic device 302.

According to an example embodiment, the acquiring of the utterance time point information may include acquiring the first voice quality information corresponding to the first electronic device 301 in a situation in which the first electronic device 301 is worn on a part of a human body, and in response to a situation in which the first voice quality information has a value equal to or smaller than a configured threshold value, acquiring the utterance time point information of the user.

According to an example embedment, the acquiring of the utterance time point information may include detecting, using the utterance detection sensor 312, vibration according to utterance of the user, and acquiring, based on information on the detected vibration, the utterance time point information.

The method according to an example embodiment may further include suspending reception of a voice signal through a second microphone 372 included in the second electronic device 302 in case that the first electronic device 301 is selected.

The method according to an example embodiment may further include selecting a second microphone 372 of the second electronic device 302 in case that the second electronic device 302 is selected based on the first voice quality information and the second voice quality information.

The method according to an example embodiment may further include in response to the selection of the second microphone 372 of the second electronic device 302, suspending reception of a voice signal through the first microphone 322 of the first electronic device 301, and maintaining output of an audio signal through the first electronic device 301.

The method according to an example embodiment may further include generating at least one packet including the utterance time point information, and transmitting the at least one packet to the second electronic device 302.

The method according to an example embodiment may further include identifying a third electronic device 303 operatively connected to the first electronic device 301 and not worn on a part of a human body, calculating a distance spaced apart from the third electronic device 303, sharing the utterance time point information with the third electronic device 303 in case that the calculated distance is identified to be within a configured threshold distance, acquiring, based on the utterance time point information, first voice quality information corresponding to the first electronic device 301 and third voice quality information corresponding to the third electronic device 303, selecting one of the first electronic device 301 and the third electronic device 303, based on the first voice quality information and the third voice quality information, and in case that the third electronic device 303 is selected, activating a microphone included in the third electronic device 303.

The method according to an example embodiment may further include acquiring, from the communicatively connected third electronic device 303, information related to proximity to the third electronic device 303, and in response to a situation in which the third electronic device 303 is in proximity, sharing the utterance time point information with the third electronic device 303.

According to various example embodiments, a non-transitory computer-readable storage medium (or a computer program product) storing one or more programs for executing a method for selecting a microphone may be described. According to an example embodiment, the one or more programs may include instructions which cause, when executed by a processor 120 of an electronic device 101, the electronic device to perform the operations of in response to a situation in which a first electronic device 301 is worn on a part of a human body, acquiring utterance time point information of a user using an utterance detection sensor 312 of the first electronic device 301, sharing the acquired utterance time point information with a second electronic device 302 operatively and communicatively connected to the first electronic device 301, acquiring, based on the utterance time point information, first voice quality information corresponding to the first electronic device 301 and second voice quality information corresponding to the second electronic device 302, selecting one of the first electronic device 301 and the second electronic device 302, based on the first voice quality information and the second voice quality information, and in case that the first electronic device 301 is selected, selecting a first microphone 322 of the first electronic device 301.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. It is intended that features described with respect to separate embodiments, or features recited in separate claims, may be combined unless such a combination is explicitly specified as being excluded or such features are incompatible. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), the element may be coupled with the other element directly (e.g., wiredly), wirelessly, or via a third element.

As used in connection with various embodiments of the disclosure, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the "non-transitory" storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A first electronic device comprising:
a wearing detection sensor;
an utterance detection sensor;
a communication circuit configured to provide a communicative connection to a second electronic device;
a first microphone;
memory; and
at least one processor, comprising processing circuitry, operatively connected to the wearing detection sensor, the utterance detection sensor, the communication circuit, the first microphone, and the memory,
wherein at least one processor, individually and/or collectively, is configured to cause the first electronic device to:
in response to the first electronic device being worn on a part of a human body, acquire utterance time point information of a user using the utterance detection sensor;
share the acquired utterance time point information with the second electronic device through the communication circuit;
based on the utterance time point information, acquire first voice quality information corresponding to the first electronic device and second voice quality information corresponding to the second electronic device;
based on the first voice quality information and the second voice quality information, select one of the first electronic device and the second electronic device; and
based on the first electronic device being selected, select the first microphone of the first electronic device.

2. The first electronic device of claim 1, wherein at least one processor, individually and/or collectively, is configured to cause the first electronic device to:
based on the first electronic device and the second electronic device being worn on a part of a human body, identify the second electronic device being removed from the part of the human body; and
in response to the removal of the second electronic device from the part of the human body, share the utterance time point information of the user with the second electronic device.

3. The first electronic device of claim 1, wherein at least one processor, individually and/or collectively, is configured to cause the first electronic device to:
based on the first electronic device being worn on a part of a human body, acquire the first voice quality information corresponding to the first electronic device; and
in response to the first voice quality information being lowered to or below a configured threshold value, acquire the utterance time point information of the user.

4. The first electronic device of claim 1, wherein at least one processor, individually and/or collectively, is configured to cause the first electronic device to:
detect vibration according to utterance of the user using the utterance detection sensor; and
based on information on the detected vibration, acquire the utterance time point information.

5. The first electronic device of claim 1, wherein at least one processor, individually and/or collectively, is configured to cause the electronic device to, based on the first electronic device being selected, suspend an operation of receiving a voice signal through a second microphone included in the second electronic device.

6. The first electronic device of claim 1, wherein at least one processor, individually and/or collectively, is configured to cause the first electronic device to, based on the second electronic device being selected based on the first voice quality information and the second voice quality information, select a second microphone of the second electronic device.

7. The first electronic device of claim 6, wherein at least one processor, individually and/or collectively, is configured to cause the first electronic device to:
in response to the selection of the second microphone of the second electronic device, suspend an operation of receiving a voice signal through the first microphone of the first electronic device; and
maintain outputting of an audio signal through the first electronic device.

8. The first electronic device of claim 1, wherein at least one processor, individually and/or collectively, is configured to cause the first electronic device to transmit at least one packet comprising the utterance time point information to the second electronic device through the communication circuit.

9. The first electronic device of claim 1, wherein at least one processor, individually and/or collectively, is configured to cause the first electronic device to:
identify a third electronic device operatively connected through the communication circuit and not worn on a part of a human body;
calculate a spaced distance from the third electronic device to the first electronic device;
based on the calculated distance being within a configured threshold distance, share the utterance time point information with the third electronic device;
based on the utterance time point information, acquire first voice quality information corresponding to the first electronic device and third voice quality information corresponding to the third electronic device;
based on the first voice quality information and the third voice quality information, select one of the first electronic device and the third electronic device; and
based on the third electronic device being selected, select a microphone included in the third electronic device.

10. The first electronic device of claim 9, wherein at least one processor, individually and/or collectively, is configured to cause the first electronic device to:
acquire, from the communicatively connected third electronic device, proximity-related information of the third electronic device; and
in response to the third electronic device being within a specified proximity of the first electronic device, share the utterance time point information with the third electronic device.

11. A method for selecting a microphone, the method comprising:
in response to a first electronic device being worn on a part of a human body, acquiring utterance time point information of a user using an utterance detection sensor of the first electronic device;
sharing the acquired utterance time point information with a second electronic device operatively and communicatively connected to the first electronic device;
based on the utterance time point information, acquiring first voice quality information corresponding to the first electronic device and second voice quality information corresponding to the second electronic device;
based on the first voice quality information and the second voice quality information, selecting one of the first electronic device and the second electronic device; and
based on the first electronic device being selected, selecting a first microphone of the first electronic device.

12. The method of claim 11, wherein the sharing of the utterance time point information comprises:
based on the first electronic device and the second electronic device being worn on a part of a human body, identifying the second electronic device being removed from the part of the human body; and
in response to the removal of the second electronic device from the part of the human body, sharing the utterance time point information of the user with the second electronic device.

13. The method of claim 11, wherein the acquiring of the utterance time point information comprises:
based on the first electronic device being worn on a part of a human body, acquiring the first voice quality information corresponding to the first electronic device; and
in response to the first voice quality information being lowered to or below a configured threshold value, acquiring the utterance time point information of the user.

14. The method of claim 11, wherein the acquiring of the utterance time point information comprises:
detecting vibration according to utterance of the user using the utterance detection sensor; and
based on information on the detected vibration, acquiring the utterance time point information.

15. The method of claim 11, further comprising:
based on the first electronic device being selected, suspending an operation of receiving a voice signal through a second microphone included in the second electronic device.

16. The method of claim 11, further comprising:
based on the second electronic device being selected based on the first voice quality information and the second voice quality information, selecting a second microphone of the second electronic device.

17. The method of claim 11, further comprising:
in response to the selection of the second microphone of the second electronic device, suspending an operation of receiving a voice signal through the first microphone of the first electronic device; and
maintaining outputting of an audio signal through the first electronic device.

18. The method of claim 11, further comprising:
identifying a third electronic device operatively connected through the communication circuit and not worn on a part of a human body;
calculating a spaced distance from the third electronic device to the first electronic device;
based on the calculated distance being within a configured threshold distance, sharing the utterance time point information with the third electronic device;
based on the utterance time point information, acquiring first voice quality information corresponding to the first electronic device and third voice quality information corresponding to the third electronic device;
based on the first voice quality information and the third voice quality information, selecting one of the first electronic device and the third electronic device; and
based on the third electronic device being selected, selecting a microphone included in the third electronic device.

19. The method of claim 11, further comprising:
acquiring, from the communicatively connected third electronic device, proximity-related information of the third electronic device; and
in response to the third electronic device being within a specified proximity of the first electronic device, sharing the utterance time point information with the third electronic device.

20. A non-transitory computer-readable storage medium storing one or more programs for executing a method for selecting a microphone,
wherein the one or more programs, when executed by at least one processor, comprising processing circuitry, individually and/or collectively, of a first electronic device, cause the electronic device to:
in response to a first electronic device being worn on a part of a human body, acquiring utterance time point information of a user using an utterance detection sensor of the first electronic device;
sharing the acquired utterance time point information with a second electronic device operatively and communicatively connected to the first electronic device;
based on the utterance time point information, acquiring first voice quality information corresponding to the first electronic device and second voice quality information corresponding to the second electronic device;
based on the first voice quality information and the second voice quality information, selecting one of the first electronic device and the second electronic device; and
based on the first electronic device being selected, selecting a first microphone of the first electronic device.
